(19) United States
(12) Patent Application Publication
(10) Pub. No.: US 2010/0206383 A1
(43) Pub. Date: Aug. 19, 2010

(54) FEED HOPPER FOR POSITIVE DISPLACEMENT PUMPS

(75) Inventors: Jonathan Getliff, Kincardineshire (GB); Brian Jamieson, Aberdeenshire (GB)

Correspondence Address: OSHA LIANG/MI, TWO HOUSTON CENTER, 909 FANNIN STREET, SUITE 3500, HOUSTON, TX, 77010, US

(73) Assignee: M-I LLC, Houston, TX (US)

(21) Appl. No.: 12/670,347

(22) PCT Filed: Jul. 23, 2008
(86) PCT No.: PCT/US08/70841

§ 371 Date: Apr. 26, 2010

Related U.S. Application Data
(60) Provisional application No. 60/951,629, filed on Jul. 24, 2007.

(51) Int. Cl. F17D 1/00

(52) U.S. Cl. 137/1; 137/268

(57) ABSTRACT

A drill cuttings transfer device that includes a pump having an inlet for receiving the drill cuttings and an outlet for discharging the drill cuttings; and a feed hopper in fluid connection to the inlet of the pump, the feed hopper comprising: at least one air nozzle configured to provide a flow of air to the drill cuttings is disclosed.

### BACKGROUND

1. Field of the Disclosure

Embodiments disclosed herein relate generally to apparatus, systems, and methods for transferring materials at drilling locations. More specifically, embodiments disclosed herein relate to apparatus, systems, and methods for transferring drill cuttings between cuttings storage and cuttings remediation operations at offshore drilling locations.

2. Background Art

When drilling or completing wells in earth formations, various fluids (“well fluids”) are typically used in the well for a variety of reasons. Common uses for well fluids include: lubrication and cooling of drill bit cutting surfaces while drilling generally or drilling-in (i.e., drilling in a targeted petroleum bearing formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, implacing a packer fluid, abandoning the well or preparing the well for abandonment, and otherwise treating the well or the formation.

As stated above, one use of well fluids is the removal of rock particles (“cuttings”) from the formation being drilled. However, because of the oil content in the recovered cuttings, particularly when the drilling fluid is oil-based or hydrocarbon-based, the cuttings are an environmentally hazardous material, making disposal a problem. That is, the oil from the drilling fluid (as well as any oil from the formation) becomes associated with or adsorbed to the surfaces of the cuttings.

Complicating the treatment of drill cuttings, when a wellbore fluid brings cuttings to the surface, the mixture is typically subjected to various mechanical treatments (shakers, centrifuges, etc) to separate the cuttings from the recyclable wellbore fluid. However, the separated drill cuttings, which still possess a certain portion of oil from the wellbore fluid absorbed thereto, are in the form of a very thick heavy paste, creating difficulties in handling and transportation. Thus, frequently, in offshore applications, the thick drill cuttings paste is slurrified with a carrier fluid, typically an oil-based fluid, to allow for ease in pumping and handling the drill cuttings paste.

The transfer of the drill cuttings between waste remediation equipment including, for example, shakers, centrifuges, storage vessels, and thermal desoption units, may be facilitated via gravity feeds, pumps, pneumatic transfer devices, and other means for transferring drill cuttings at a drilling location. One such method of transferring drill cuttings includes the use of pumps. However, as drill cuttings are added to feed hoppers of the pumps, the drill cuttings often block pump inlets, thereby resulting in poor pumping performance and transfer system efficiency.

Accordingly, there exists a need for improvements in drill cuttings transfer and treatment.

### SUMMARY OF THE DISCLOSURE

In one aspect, embodiments disclosed herein relate to a drill cuttings transfer device that includes a pump having an inlet for receiving the drill cuttings and an outlet for discharging the drill cuttings; and a feed hopper in fluid connection to the inlet of the pump, the feed hopper comprising: at least one air nozzle configured to provide a flow of air to the drill cuttings.

In another aspect, embodiments disclosed herein relate to a system for treatment of drill cuttings that includes a storage vessel configured to receive contaminated drill cuttings; a positive displacement pump having a feed hopper in fluid connection with the storage vessel, the feed hopper having at least one air nozzle configured to provide a flow of air to the contaminated drill cuttings; and a drill cuttings treatment device in fluid connection to the positive displacement pump.

In yet another aspect, embodiments disclosed herein relate to a method of transferring drill cuttings that includes transmitting drill cuttings into a feed hopper; injecting a flow of air into the feed hopper to disperse the drill cuttings; actuating a positive displacement pump fluidly connected to the feed hopper; and providing a flow of drill cuttings to a cuttings remediation operation.

Other aspects and advantages of the invention will be apparent from the following description and the appended claims.

### BRIEF DESCRIPTION OF DRAWINGS

FIG. 1 is a schematic view of a positive displacement pump according to one embodiment of the present disclosure.

FIG. 2 is a close perspective view of a feed hopper of a positive displacement pump according to one embodiment of the present disclosure.

FIG. 3 is a close perspective view of air nozzles in a feed hopper of a positive displacement pump according to one embodiment of the present disclosure.

FIG. 4 is a close perspective view of a feed hopper of a positive displacement pump according to one embodiment of the present disclosure.

FIG. 5 is a schematic view of a drill cuttings transfer device according to one embodiment of the present disclosure.

FIG. 6 is a schematic of a system according to one embodiment of the present disclosure.

FIG. 7 is a schematic of a pressurized vessel according to one embodiment of the present disclosure.

FIG. 8 is a schematic of a pressurized vessel according to another embodiment of the present disclosure.

FIG. 9 is a schematic of a reactor unit according to one embodiment of the present disclosure.

FIG. 10 is a schematic of a system according to another embodiment of the present disclosure.

### DETAILED DESCRIPTION

In one aspect, embodiments disclosed herein relate to apparatus, systems, and methods for transferring materials at drilling locations. More specifically, embodiments disclosed herein relate to apparatus, systems, and methods for transferring drill cuttings between cuttings storage and treatment operations at offshore drilling locations.

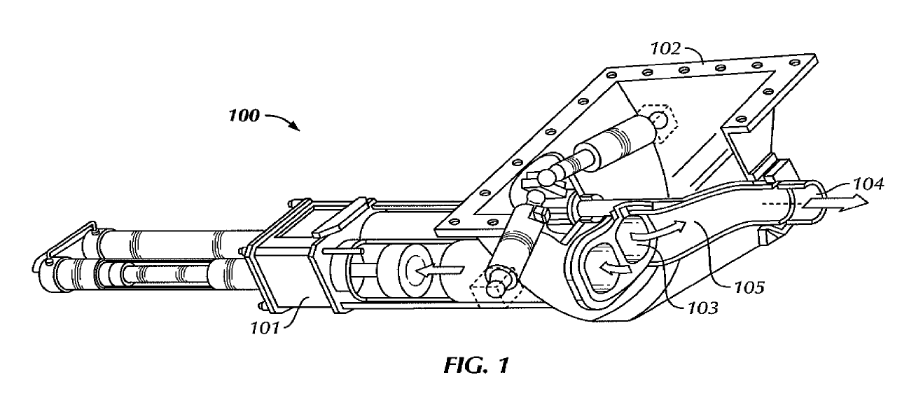

Referring initially to FIG. 1, a drill cuttings transfer device 100 including a pump 101 and a feed hopper 102 is shown. In this embodiment, pump 101 has an inlet 103 for receiving the drill cuttings and an outlet 104 for discharging the drill cuttings. Generally, pump 101 is a device used to move liquids, slurries, or solids, and in this embodiment, pump 101 is a positive displacement pump. Positive displacement pump 101 provides a flow of drill cuttings by trapping a fixed amount of the drill cuttings in chamber 105 then displacing the trapped volume of drill cuttings through outlet 104. Examples of positive displacement pumps may include rotor pumps, multiple rotor pumps, diaphragm pumps, rotary-type, and reciprocating-type pumps. Those of ordinary skill in the art will appreciate that any type of positive displacement pump 101 used in accordance with embodiments herein may find benefit from the present disclosure.

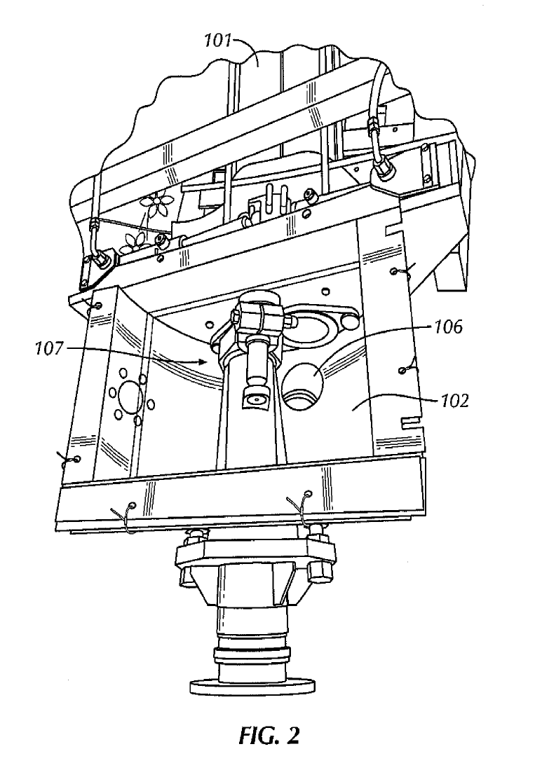

Feed hopper 102 is a receiving area such that drill cuttings may be transmitted from upstream remediation, cleanings operations, or storage vessels (not shown) to pump 101. As such, feed hopper 102 is fluidly connected to at least inlet 103 of pump 101. Referring to FIG. 2, a close perspective view of feed hopper 102 fluidly connected to positive displacement pump 101 is shown. In this embodiment, feed hopper 102 is illustrated having a hopper outlet 106 in fluid connection with the inlet (not illustrated) of pump 101. Thus, as drill cuttings are transmitted into feed hopper 102, they may generally flow in a downward direction into hopper outlet 106 through the pump inlet (not shown), and into the chamber (not shown) of pump 101.

Feed hopper 102 may have any number of internal components, such as augers (not shown), to facilitate the movement of drill cuttings therethrough. Additionally, feed hopper 102 may be of any geometry known to those of skill in the art. Examples of feed hopper 102 geometry may include a receiving portion 107 with slopped sides, such that drill cuttings will move through feed hopper 102 in a generally downward direction. Thus, the movement of drill cuttings through feed hopper 102 may initially be facilitated by gravity. However, as described above, as the drill cuttings begin coalescing toward feed hopper outlet 106, the flow rate of the cuttings into pump 101 may decrease.

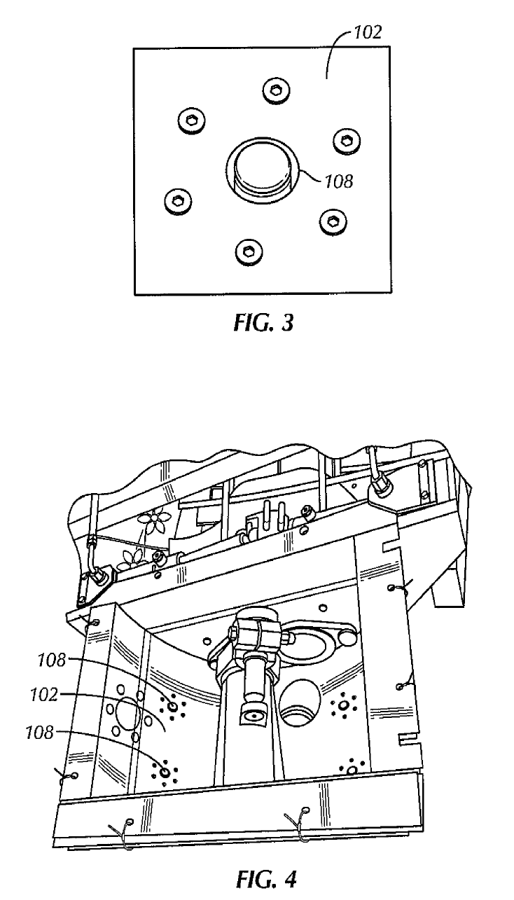

Referring to FIGS. 3 and 4 together, a close perspective view of an air nozzle 108 disposed on a surface of feed hopper 102 is shown. As illustrated in FIG. 3, air nozzle 108 is disposed as an integral portion of feed hopper 102 lying flush with the body of feed hopper 102. In alternate embodiments, air nozzle 108 may be a projected aperture from the feed hopper body or may include a recessed portion of the feed hopper body. Depending on the requirements of the drilling operation, and the type of cuttings being transferred, the geometry and type of air nozzles 108 used may vary. Exemplary air nozzle types may include propulsion nozzles, blow off nozzles, flexible nozzles, round nozzles, flat nozzles, laval nozzles, pulse air nozzles, or air knife nozzles. In certain embodiments, flat air nozzles that produce a generally broad and flat air stream may increase the dispersion of drill cuttings in feed hopper 102. However, in alternate embodiments, laval air nozzles, which may provide a concentrated air stream may be useful in directing drill cuttings toward feed hopper outlet 106. Those of ordinary skill in the art will appreciate that any type of nozzle that may form an outlet for compressed air may be used with embodiments disclosed herein.

In certain embodiments, a plurality of air nozzles 108 may be used to further increase the dispersion efficiency of the system. As illustrated in FIG. 4, the plurality of air nozzles 108 may be disposed on the body of feed hopper 102 in groups. In one aspect, feed hopper 102 may include two groups of air nozzles. A first group including air nozzles 108a may be disposed on one side of feed hopper 102, while a second group including air nozzles 108b may be disposed on an opposing side. By varying the placement of air nozzles 108 on feed hopper 102, a particular flow path of air through feed hopper 108 may be achieved. Those of ordinary skill in the art will appreciate that by providing a flow of air in a direction such that drill cuttings are directed into feed hopper outlet 106, the operating efficiency of the drill cuttings transfer device may be increased.

In alternate embodiments, feed hopper 102 may include one group, two groups, or any number of groups of air nozzles 108. Additionally, air nozzles 108 may be disposed to provide any direction of airflow that may disperse accretive drill cuttings. Those of ordinary skill in the art will appreciate that air nozzles 108 may be configured to provide a controlled airflow for a given duration, or in alternate embodiments, may be configured to provide for a substantially continuous airflow. Specific types of airflow will be discussed in detail below, but generally, any type of airflow that allows for the dispersion of drill cuttings may be used in accordance with embodiments disclosed herein.

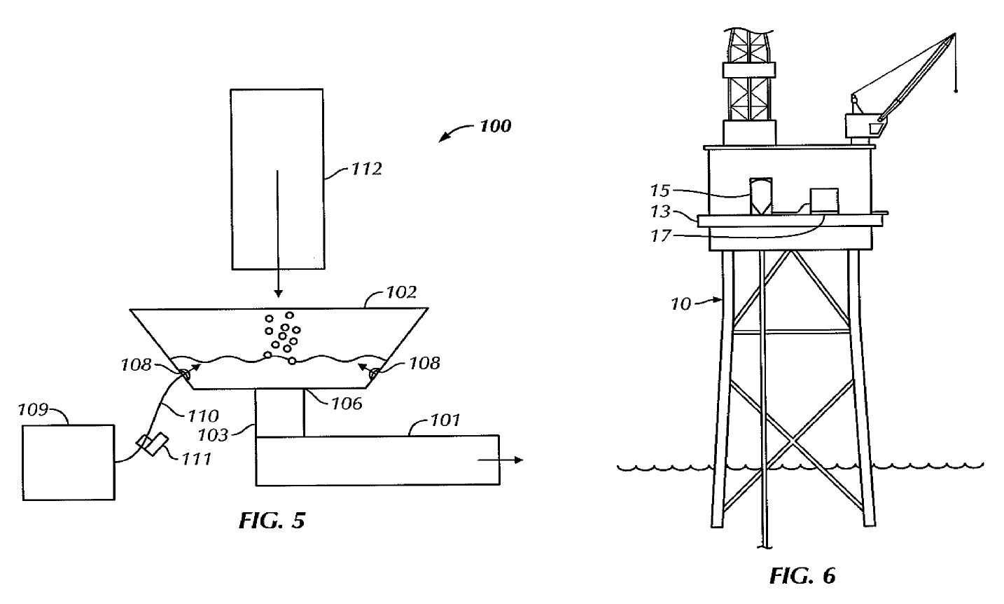

Referring to FIG. 5, a schematic view of a drill cuttings transfer device 100 is shown. In this embodiment, drill cuttings transfer device 100 includes feed hopper 102 fluidly connected to pump 101 via a connection of pump inlet 103 to feed hopper outlet 106. A plurality of air nozzles 108 are disposed on feed hopper 102, and receive an airflow from an air supply device 109 via an air line 110. Air supply device 109 may include an air compressor, or any other device known in the art for providing airflow.

Additionally, in certain embodiments, disposed on air line 100, or integral to air supply device 109, an air modulation device 111 may be configured control a flow of air to the air nozzles. Air modulation device 111 may include any number of solenoid valves (not shown), switches (not shown), and valves (not shown) for controlling a flow of air therethrough. In one aspect, air modulation device 111 may include a pulse air system, thereby allowing for a specific duration and intensity of air flow. In such an aspect, air modulation device 111 may include a programmable logic controller, or other control means, to modulate the flow of air according to the requirements of a drilling operation or according to the instructions of a drilling engineer. As such, a drilling engineer may select an air profile including specific durations and delays of air flow to provide an optimized flow of air between air supply device 109 and nozzles 108. Those of ordinary skill in the art will appreciate that by modulating the flow of air, accretive drill cuttings may be more efficiently dispersed, and the operation of drill cuttings transfer device 100 may be improved.

In one embodiment, drill cuttings transfer device 100 may also include a plurality of sensors disposed in feed hopper 102 or pump 101 for determining, for example, a flow of drill cuttings through the system. Examples of sensors may include density sensors, conductivity sensors, and flow rate sensors. Such sensors may be operatively connected to a programmable logic controller such that the conditions of drill cuttings transfer device 100 may be monitored. In one aspect, the sensors may provide data to the programmable logic controller indicating that a flow rate has dropped below an optimum value. The programmable logic controller may then inform a drilling engineer that a condition indicating poor flow rate has occurred. The drilling engineer may then actuate air nozzles, to disperse accretive drill cuttings in feed hopper 102, thereby increasing the flow rate, and resolving the condition.

In another aspect, the programmable logic controller may automatically start a dispersion sequence by providing instructions to air supply device 109 and/or air modulation device 111. Thus, the programmable logic controller may provide instructions for providing a flow of air to disperse the accretive drill cuttings. Likewise, when sensors provide data to the programmable logic controller indicating an optimal flow rate has been achieved, the programmable logic controller may provide instructions to turn off the air flow. Thus, one or more sensors and/or programmable logic controllers may be used to determine a condition of drill cuttings in feed hopper 102, such that a flow of air may be modulated based on the condition.

The programmable logic controller may also be used to provide a specific air flow profile. For example, in drill cuttings transfer device 100 having a pulse air system, a flow of air may be modulated such that intermittent bursts of air of a specific duration disperse the accretive drill cuttings. In other systems, substantially continuous flows of air may be provided to feed hopper 102. In still other embodiments, combinations of substantially continuous air flow and pulsed air flow may be used to both disperse and direct drill cuttings through feed hopper 102 into pump 101. Thus, those of ordinary skill in the art will appreciate that an air profile may be adjusted to provide for an optimized flow of drill cuttings through drill cuttings transfer device 100.

Still referring to FIG. 5, in operation, drill cuttings may initially enter feed hopper 102 via a flow conduit 112. As drill cuttings are transmitted into feed hopper 102, they may begin to exhibit plastic behavior and coalesce toward the bottom of feed hopper 102. As the drill cuttings form a mass around feed hopper outlet 106, the flow of cuttings therethrough may be interrupted. When such a condition occurs, a flow of air may be injected into feed hopper 102 through nozzles 108 to disperse the mass of drill cuttings. Pump 101 may then be actuated, and a flow of drill cuttings to downstream remediation operations may continue.

In operation, drill cuttings transfer devices in accordance with the embodiments of the present disclosure may be incorporated into drilling waste management systems. Drilling waste management systems may include drill cuttings remediation systems, storage systems, re-injection systems, or other systems used at drilling locations. Those of ordinary skill in the art will appreciate that drill cuttings transfer devices as disclosed herein may be used in land-based drilling operations. However, the devices may be particularly useful as part of offshore drilling operations. Exemplary uses of the apparatus, methods, and systems disclosed herein in drilling waste management systems in offshore drilling operations will be discussed in detail below.

Referring to FIG. 6, an offshore oil rig 10 on which the treatment of drill cuttings may be performed according to one embodiment of the present disclosure is shown. On the platform 13 of offshore oil rig 10, a pressurized vessel 15 is located. Drill cuttings, after undergoing traditional screening process, are loaded into pressurized vessel 15. From pressurized vessel 15, drill cuttings may exit the pressurized vessel 15 and be loaded into reactor unit 17. In reactor unit 17, at least a portion of the contaminants adsorbed onto the surface of drill cuttings may be removed.

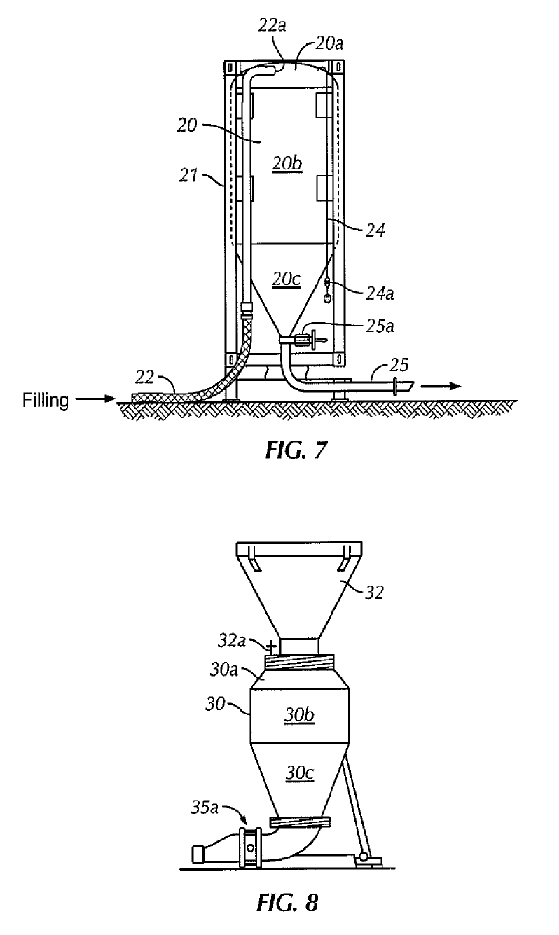

Referring to FIG. 7, a pressurized vessel according to one embodiment of the present disclosure is shown. As shown in FIG. 7, a pressurized vessel 20 may be located within a support frame 21. Pressurized vessel 20 has a part spherical upper end 20a, a cylindrical body section 20b, and a lower angled section 20c. At the lowermost end of the angled section 20c, the vessel is provided with a discharge valve 25a having connected thereto a pipe 25. A filling pipe 22 extends into each pressurized vessel 20 via an inlet valve 22a at the upper end 20a of pressurized vessel 20. Also extending into upper end 20a of pressurized vessel 20 is a compressed air line 24 having valves 24a.

In a filling operation, prior to loading any drill cuttings into pressurized vessel 20, inlet valve 22a is closed. A vent valve (not shown) may be opened to equalize the vessel pressure to ambient air. The inlet valve 22a is opened, and the drill cuttings are fed into the pressurized vessel 20. The vent valve may be opened to vent displaced air from the vessel. When the pressurized vessel 20 is full, the inlet valve 22a and vent valve are closed, sealing the pressurized vessel. In order to empty a vessel that is filled via pipe 22, inlet valve 22a is closed, valve 25a is opened, and compressed air is fed into the vessel 20 via air line 24. The drill cuttings are forced out of vessel 20 under the pressure of the compressed air and into pipe 25. While the above embodiment refers to application of compressed air into the pressurized vessel, one of ordinary skill in the art would recognize that it is within the scope of the present disclosure that other inert gases, for example, compressed nitrogen, may be used in place of compressed air. In a particular embodiment, the compressed gas applied to the pressurized vessel may be within a pressure ranging from about 4 to 8 bar.

Due to the angle of the lower angled section being less than a certain value, the material flow out of the vessel is of the type known as mass flow and results in all of the material exiting uniformly out of the vessel. In the case of mass flow, all of the drill cuttings material in the vessel descend or move in a uniform manner towards the outlet, as compared to funnel flow (a central core of material moves, with stagnant materials near the hopper walls). It is known that the critical hopper angle (to achieve mass flow) may vary depending upon the material being conveyed and/or the vessel material. In various embodiments, the angle (from the vertical axis) for mass flow to occur may be less than 40°. One of ordinary skill in the art would recognize that in various embodiments the lower angled section may be conical or otherwise generally pyramidal in shape or otherwise reducing in nature, e.g., a wedge transition or chisel, to promote mass flow. In a particular embodiment, the lower angled section has a minimum discharge dimension of at least 12 inches (300 mm) After exiting the vessel, the material is typically conveyed in the form of a semi-solid slug along pipe 25.

Referring to FIG. 8, an alternative embodiment of a pressurized vessel is shown. As shown in FIG. 8, pressurized vessel 30 has an upper end 30a, a body section 30b, and a lower angled section 30c. Connected at its upper end 30a is feed hopper 32 with an inlet valve 32a therebetween. At the lowermost end of the conical section 30c, the vessel is provided with a discharge valve 35a.

In a filling operation, inlet valve 32a is opened, and the drill cuttings are fed into the pressurized vessel 30 through the feed hopper 32, which may optionally be a vibrating feed hopper. When the pressurized vessel 30 is full, the inlet valve 32a is closed, sealing the pressurized vessel. In order to empty the valve, inlet valve 32a remains closed, discharge valve 35a is opened, and compressed air is fed into the vessel 30 via air line (not shown). The drill cuttings are forced out of vessel 30 under the pressure of the compressed air and into a discharge pipe (not shown). Due to the selected angle of the lower angled section being less than a certain value, the material flow out of the vessel is of the type known as mass flow and results in all of the material exiting uniformly out of the vessel.

One of ordinary skill in the art would recognize that in alternate embodiments, any number of pressurized vessels may be used, which may be connected in series or with a common material filling pipe and a common material discharge pipe. In a particular embodiment, drill cuttings may be conveyed from shakers (or other separation means) into a pressurized vessel having a feed chute attached thereto, such as that described in FIG. 8, and then be discharged from the first pressurized vessel and conveyed into a second pressurized vessel, such as that described in FIG. 7.

Pressurized vessel 20 may be filled with drill cuttings by various means. In one embodiment, filling pipe 22 and thus inlet valve 22a, which empty drill cuttings into pressurized vessel 20, may be supplied with drill cuttings for processing by vacuum assistance. For example, a vacuum collection system, as described in U.S. Pat. Nos. 5,402,857, 5,564,509, and 6,213,227, which are assigned to the present assignee and incorporated herein by reference in there entirety, may be used to deliver drill cuttings from a cuttings trough to the pressurized vessel of the present disclosure. In another embodiment, cuttings may be fed directly from a shaker and/or cuttings trough to a pressurized vessel, such as through a feed hopper, as shown in FIG. 8.

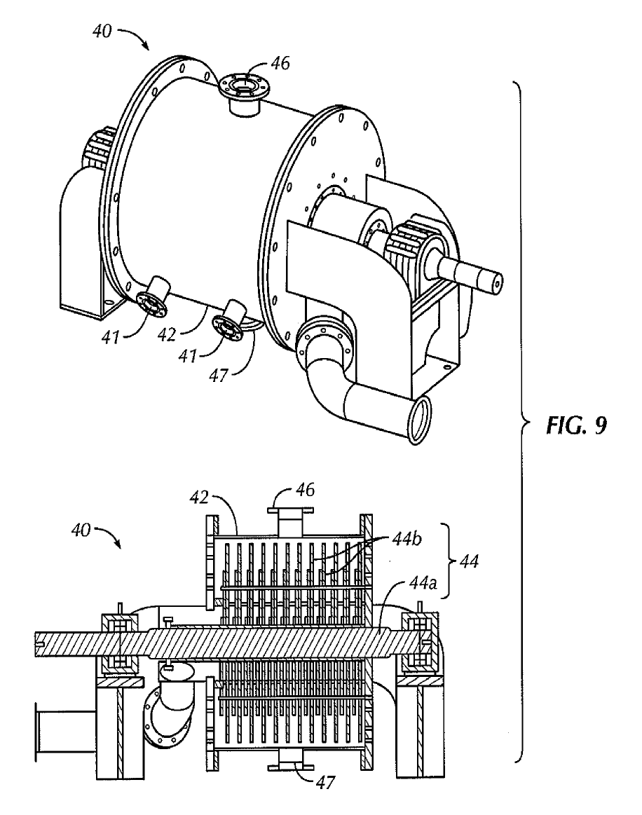

As the addition of compressed air into the pressurized vessel(s) discharges the drill cuttings therefrom, the cuttings may be conveyed through discharge pipes into a reactor unit wherein at least a portion of the contaminants adsorbed to the surface of the cuttings may be removed. Referring to FIG. 9, a reactor unit according to one embodiment of the present disclosure is shown. As shown in FIG. 9, reactor unit 40 includes a cylindrical processing chamber 42 into which drill cuttings are loaded through inlet(s) 41. While not shown in FIG. 9, one of ordinary skill in the art would recognize that inlet(s) 41 may receive drill cuttings directly from a pressurized vessel, such as those shown in FIGS. 7 and 8, or indirectly through a feed hopper, as known in the art.

Mounted in processing chamber 42 is a rotor 44. Rotor 44 includes a shaft 44a and a plurality of fixed rotor arms 44b. Rotor arms 44b extend radially from shaft 44a in axially aligned rows. Rotor 44 rotates within processing chamber 42 via a motor (not shown). As rotor 44 rotates within processing chamber 42, an annular bed of drill cuttings is formed against the inner surface of the processing chamber 42. The rotation of the arms may vary, for example, such that the tangential velocity of the ends of the rotor arms ranges from about 10 to 100 m/s, and from about 30 to 40 m/s in other embodiments. Frictional forces, and thus heat, are generated as the drill cuttings interact with the inner surfaces of the processing chamber 42. As the generated heat amounts, the contaminants adsorbed to the surface of the cuttings may be vaporized, exiting the reactor unit through vapor outlets 46. Dried drill cuttings may exit the reactor vessel through outlets 47.

In one embodiment, the cylindrical processing chamber having a diameter ranging from 0.5-5 m, and about 1 m in another embodiment. The number of rotor arms may depend on the particular size of the processing chamber, but may range, in various embodiments, from 10-100 arms per square meter of the inner wall of the processing chamber. Further, the arms may extend radially toward the inner wall of the processing chamber to a clearance of less than 0.1 m. However, one of ordinary skill in the art would recognize that the number of rotor arms, etc, may vary and depend upon the selected size of the processing chamber.

Other reactor units that may be used in combination with the pneumatic transfer system disclosed herein may include those used onshore for the treatment of contaminated drill cuttings such as, for example, the reactor unit described in U.S. Patent Publication No. 2004/0149395, which is herein incorporated by reference in its entirety. One particular example of a reactor vessel suitable for use in the present disclosure is commercially available from Thermtech (Bergen, Norway) under the trade name Thermomechanical Cuttings Cleaner (TCC). Other reactor units that may be used in conjunction with the pressurized vessels as described herein may include those described in U.S. Pat. No. 6,658,757 and WO 06/00340, which are herein incorporated by reference in their entirety.

As described in U.S. Patent Publication No. 2004/0149395, by selecting dimensions and operating parameters for the reactor unit, a sufficient amount of energy may be generated to initiate vaporization of the contaminants adsorbed to the surface of the drill cuttings. Furthermore, because of the presence of more than one contaminant having differing boiling points, the vaporization of the contaminant having a higher boiling point may occur at a temperature less than the atmospheric boiling point. That is, the presence of one component, e.g., an aqueous fluid, may provide for a partial pressure of the gas phase of a second component, e.g., oil, less than atmospheric pressure, thus reducing the boiling point of the second component. In a particular embodiment, the contaminants include both an oil phase and an aqueous phase. In other embodiments, a aqueous phase may be added to the reactor, such as in the form of vapors, to reduce the partial pressure of the oil contaminants and reduce the amount of energy necessary to vaporize the oil contaminants.

Typically, drilling fluids, and thus drilling contaminants, have a water/oil ratio of at least about 1:2 by mass. Oil-based fluids used in wellbore fluids have an average molecular weight of 218 g/mol (corresponding to an average carbon chain length of C₁₆), whereas water has a molecular weight of 18 g/mol. With a mass ratio of at least 1:2, the volume fraction of oil vapors when all water and oil has evaporated will be 14% [(2/216)/(1/18+2/216)]. Such a partial pressure may allow for the boiling point reduction of approximately 50° C. for the oil portion.

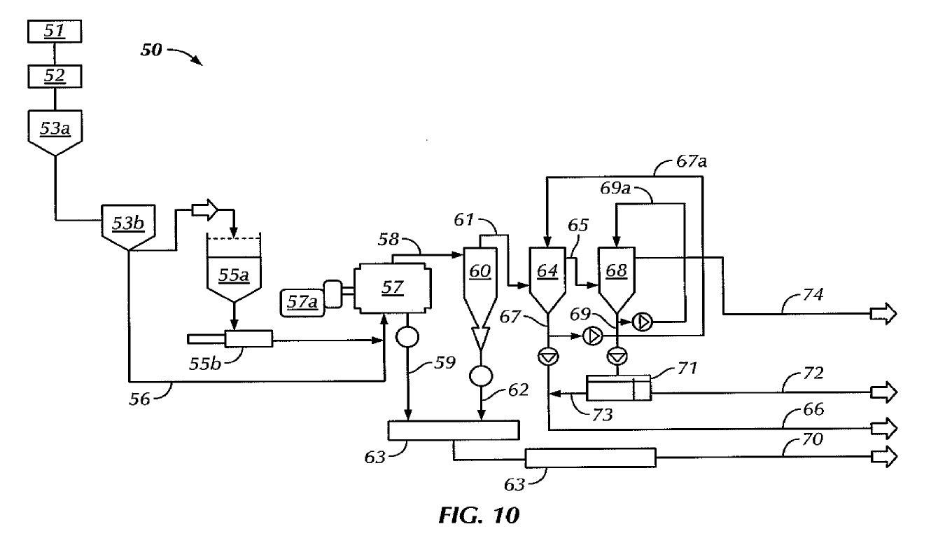

Referring to FIG. 10, another embodiment of a treatment system of the present disclosure is shown. As shown in FIG. 10, drill cuttings 51 arising from the drilling process are subjected to a screening device 52, e.g., shakers. From the shakers, the screened cuttings are loaded into an initial feed hopper (not shown) attached to first pressurized vessel 53. From first pressurized vessel 53a, drill cuttings are conveyed into a second pressurized vessel 53b via the addition of a compressed gas (not shown). As illustrated, system 50 includes a first pressurized vessel 53a and a second pressurized vessel 53b; however, one of skill in the art would recognize that in various other embodiments, the system may include any number of pressurized vessels, such as a single pressurized vessel or more than two pressurized vessels. Addition of a compressed gas (not shown) into pressurized vessel 53b allows for the conveyance of drill cuttings out of pressurized vessel 53b and into reactor unit 57, either directly through feed line 56 or indirectly through feed hopper 55a and positive displacement pump 55b. In a particular embodiment, the drill cuttings may be conveyed from pressurized vessel 53b to reactor unit 57 at a rate of up to 40 MT/hr. However, one of skill in the art would recognize that the transfer rate may be dependent upon a number of factors, such as the material being transferred.

As the drill cuttings enter feed hopper 55a, they may begin to form a mass, thereby slowing the transmittance of the cuttings into positive displacement pump 55b. In accordance with the methods described above, to disperse the mass of drill cuttings, a flow of air may be provided through nozzles in feed hopper 55a. The flow of air may thereby allow the drill cuttings to enter positive displacement pump 55b at an optimized flow rate, such that the cuttings may be transferred to reactor unit 57.

In reactor unit 57, a plurality of rotor arms (not shown) are caused to rotate by the drive unit 57a, generating heat. The generation of heat vaporizes at least a portion of the contaminants 58 adsorbed to the surface of the drill cuttings 59. Contaminants 58 are evacuated from the reactor vessel 57 and passed through a cyclone 60. In cyclone 60, any particulate matter 62 that is present in contaminants 58 is separated from vapors 61. Vapors 61 are then passed through an oil condenser 64 to allow for the condensation of oil vapors and separation from vapors 65, which are then fed to water condenser 68. In some embodiments, condensed oil portion 67 may be re-circulated 67a into oil condenser 64. Optionally, condensed oil portion 67 may undergo heat exchange (not shown) prior to re-circulation into the oil condenser 64. In other embodiments, condensed oil portion 67 may be directed for collection at oil recovery 66.

Vapors 65 may be directed from oil condenser 64 to water condenser 68 to allow for the condensation of water vapors and separation from non-condensable gases 74. In some embodiments, condensed water portion 69 may be re-circulated 69a into water condenser 68. Optionally, condensed water portion 69 may undergo heat exchange (not shown) prior to re-circulation into the water condenser 68. In other embodiments, condensed water portion 69 may be directed into collection tank 71. In collection tank 71, a weir arrangement may be disposed to allow for separation of any residual oil phase 73 from recovered water 72.

Dried drill cuttings 59 exit reactor unit 57 and are conveyed through a screw conveyor 63, or the like, to solids recovery 70. Any particulate matter 62 separated from vapors 61 in cyclone 60 are also fed to solids recovery 70 via screw conveyor 63. Recovered solids 70 may, in various embodiments, be subjected to disposal (e.g., cuttings re-injection) or stored for later disposal or use. Recovered water 72 and oil 66 components may find further use, such as re-circulation into drilling fluids.

Those of ordinary skill in the art will appreciate that in alternate embodiments of waste management systems, some of the components described in FIG. 6-10 may be omitted. For example, in an alternate embodiment, drill cuttings may be transferred directing from a storage vessel to a feed hopper, such as feed hopper 55a. The cuttings may then be transferred via positive displacement pump 55b to cuttings treatment equipment, such as reactor unit 57. In other aspects, reactor unit 57 may be replaced with alternate cuttings treatment equipment such as centrifuges, cuttings dryers, or secondary shakers. Additionally, feed hopper 55a and positive displacement pump 55b may be used to facilitate the transfer of cuttings between storage vessels, for example, storage vessels located on an offshore platform and a supply vessel.

Those of ordinary skill in the art will appreciate that apparatus, systems, and methods for transferring and treating drill cuttings, as disclosed herein, may also be retrofitted into existing systems. For example, existing feed hoppers 55a and positive displacement pumps 55b may be retrofitted to include air nozzles for dispersing massed accretive drill cuttings. Such a system may be retrofitted by drilling holes in feed hopper 55a, in which nozzles are disposed. Additionally, an air supply device may be disposed proximate feed hopper 55a, and a flow of air may be provided to the nozzles via an air line in fluid connection thereto. Moreover, sensors, programmable logic controllers, and air modulation devices, as described above, may be included within the systems to further increase the operational efficiency of the entire system. Thus, existing land-based or offshore drill cuttings transfer and management systems may benefit from aspects of the embodiments disclosed herein.

Advantageously, embodiments of the present disclosure may provide a drill cuttings transfer system and device capable of increasing pumping efficiency and providing optimized flow rates. Air nozzles included with embodiments of the present disclosure may allow for the dispersion of accretive drill cuttings, thereby preventing a mass of drill cuttings from forming in components of the system. By dispersing such accretive drill cuttings, the flow rate of the drill cuttings through the system may be increased, thereby allowing for more drill cuttings to be transferred and processed by remediation equipment. Additionally, air nozzles in accordance with embodiments disclosed herein may be used to direct a flow of air to the drill cuttings to further increase the rate of flow of the drill cuttings through the system.

Also advantageously, embodiments of the present disclosure may be used in drill cuttings waste management systems to increase the efficiency of drill cuttings transfer between components of the operation. By increasing the efficiency of drill cuttings transfer between primary separation equipment and secondary equipment, the speed of the operation may be increased. Increasing the speed of the operation may thus allow for more drill cuttings to be processed in a shorter amount of time, thereby increasing the efficiency of the entire drilling operation. By increasing the efficiency of the operation, the cost of the operation may be decreased, thereby decreasing the net cost of the drilling operation. Furthermore, in certain embodiments, the actuation of the drill cuttings transfer device may be automated, thereby advantageously decreasing labor costs associated with the drilling operation.

Finally, embodiments of the present disclosure may also provide for the offshore treatment of drill cuttings including the use of pneumatic conveyance of the contaminated drill cuttings from the drilling process to a thermal desorption unit. Further, the pneumatic nature of the conveyance of the drill cuttings and the ability of the pressurized vessels to act as storage containers may allow for contaminated drill cuttings to be filled in the pressurized vessel over a period of time. However, whenever treatment of the cuttings is desired, compressed gas may be fed into the pressurized vessel, allowing for pneumatic conveyance of the drill cuttings to a thermal desorption unit in a relatively short period of time, without requiring the addition of any base oils or other carrier fluids to enable conveyance. Thus, efficiency in transportation and treatment of the drill cuttings may be obtained.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A drill cuttings transfer device comprising:
a pump having an inlet for receiving the drill cuttings and an outlet for discharging the drill cuttings; and
a feed hopper in fluid connection to the inlet of the pump, the feed hopper comprising:
at least one air nozzle configured to provide a flow of air to the drill cuttings.

2. The drill cuttings transfer device of claim 1, wherein the pump comprises a positive displacement pump.

3. The drill cuttings transfer device of claim 1, further comprising:
an air supply device in fluid connection with the at least one air nozzle, wherein the air supply device is configured to provide a flow of air to the air nozzle.

4. The drill cuttings transfer device of claim 3, further comprising:
an air modulation device configured to control the flow of air from the air supply device to the at least one air nozzle.

5. The drill cuttings transfer device of claim 4, wherein the air modulation device comprises:
a sensor configured to determine a condition of drill cuttings in the feed hopper; and
a programmable logic controller configured to modulate the flow of air to the at least one air nozzle based on the condition.

6. The drill cuttings transfer device of claim 1, further comprising a plurality of air nozzles.

7. The drill cuttings transfer device of claim 6, wherein the plurality of air nozzles are disposed on the feed hopper in at least one group.

8. The drill cuttings transfer device of claim 6, wherein the plurality of air nozzles comprise pulsed air nozzles.

9. A system for treatment of drill cuttings, comprising:
a storage vessel configured to receive contaminated drill cuttings;
a positive displacement pump having a feed hopper in fluid connection with the storage vessel, the feed hopper having at least one air nozzle configured to provide a flow of air to the contaminated drill cuttings; and
a drill cuttings treatment device in fluid connection to the positive displacement pump.

10. The system of claim 9, wherein the drill cuttings treatment device comprises:
a reactor unit in fluid connection with the positive displacement pump for separating the contaminated drill cuttings into drill cuttings and contaminants, comprising:
a processing chamber having at least one inlet and outlet; and
a rotor mounted in the processing chamber, comprising:
a shaft; and
a plurality of fixed rotor arms extending radially from the shaft.

11. The system of claim 9, wherein the storage vessel comprises a pressurized vessel adapted to allow a compressed gas to be introduced therein as the sole means for inducing movement of said contaminated drill cuttings in the pressurized vessel, whereby at least a portion of the contaminated drill cuttings is discharged from the pressurized vessel.

12. The system of claim 11, wherein the pressurized vessel comprises a lower angled section having an angle selected to enable mass flow of contaminated drill cuttings.

13. The system of claim 11, wherein the pressurized vessel comprises a plurality of internal baffles configured to divide the contaminated drill cuttings among a plurality of outlets.

14. The system of claim 9, wherein the feed hopper comprises a plurality of air nozzles.

15. A method of transferring drill cuttings, comprising:
transmitting drill cuttings into a feed hopper;
injecting a flow of air into the feed hopper to disperse the drill cuttings;
actuating a positive displacement pump fluidly connected to the feed hopper; and
providing a flow of drill cuttings to a cuttings remediation operation.

16. The method of claim 15, wherein transmitting comprises:
pneumatically conveying contaminated drill cuttings from a pressurized vessel into the feed hopper.

17. The method of claim 15, wherein the cuttings remediation operation is a reactor unit, the reactor unit comprising:
a processing chamber having at least one inlet and outlet; and
a rotor mounted in the processing chamber, comprising:
a shaft; and
a plurality of fixed rotor arms extending radially from the shaft.

18. The method of claim 15, further comprising:
determining a condition of the drill cuttings in the feed hopper.

19. The method of claim 18, further comprising:
modulating the flow of air into the feed hopper based on the condition.

20. The method of claim 15, wherein the flow of air comprises a pulsed flow.
